(19) United States
(12) Patent Application Publication
(10) Pub. No.: US 2012/0247987 A1
(43) Pub. Date: Oct. 4, 2012

(54) STACKABLE WATER METER PIT FRAMES

(76) Inventors: Samuel J. Patterson, Venice, CA (US); Margaret McCanless, El Segundo, CA (US); Kyle L. Baltz, Redondo Beach, CA (US); Derick Foster, Huntington Beach, CA (US)

(21) Appl. No.: 13/435,196

(22) Filed: Mar. 30, 2012

Related U.S. Application Data
(60) Provisional application No. 61/470,677, filed on Apr. 1, 2011.

(51) Int. Cl. B65D 88/76; G12B 9/02; G12B 9/04

(52) U.S. Cl. 206/305; 220/729

(57) ABSTRACT

A water meter pit frame includes a stacking feature that allows multiple water meter pit frames to be stacked together in a nested relationship. In one example, the stacking feature comprises a plurality of ledges formed about the outer peripheral surface of the water meter pit frame that support a second water meter pit frame.

### CROSS-REFERENCE TO RELATED APPLICATION

This application claims priority to U.S. Provisional Application No. 61/470,677 filed on Apr. 1, 2011.

### TECHNICAL FIELD

The present invention relates to a water meter pit frame that can be stacked on other frames in a nested configuration.

### BACKGROUND OF THE INVENTION

Water meter pits house equipment for monitoring an amount of water that is being supplied to a commercial property or private residence, for example. These pits are enclosed by a cover that includes a latch to securely lock the cover in place. The cover sits in a frame, which can be made from cast iron, aluminum, or plastic for example.

### SUMMARY OF THE INVENTION

A water meter pit frame includes a stacking feature that allows multiple water meter pit frames to be stacked together in a nested relationship.

In one example, the water meter pit frame comprises a body including a base portion to be supported by a water pit column and a top portion to be releasably securable to a cover. The body has an outer peripheral surface and an inner peripheral surface that defines an internal cavity. At least one stacking feature is formed on the outer peripheral surface to support a second water meter pit frame when the body is at least partially nested within the second water meter pit frame.

In one example, the stacking feature comprises a plurality of ledges formed about the outer peripheral surface of the water meter pit frame that support a second water meter pit frame.

In one example, the water meter pit frame includes a double wall configuration. In one configuration, the body includes an inner wall structure that is positioned radially inward of an outer wall structure that defines the outer peripheral surface of the body to form a pocket portion between the outer wall structure and the inner wall structure.

In one example, the inner peripheral surface of the body includes a plurality of recessed areas to receive a locating feature formed on a third water meter pit frame when the third water meter pit frame is at least partially nested within the body of the first water meter pit frame.

In one example, the water meter pit frame includes a frost plate.

In one example, the frost plate includes at least one frost plate stacking feature that allows a plurality of frost plates to be stacked in a nested relationship.

These and other features of the present invention can be best understood from the following specification and drawings, the following of which is a brief description.

### BRIEF DESCRIPTION OF THE DRAWINGS

FIG. 1 is a perspective top view of a water meter pit frame.

FIG. 2 is a side view of the frame of FIG. 1.

FIG. 3 is a top view of the frame of FIG. 1.

FIG. 4 is a bottom view of the frame of FIG. 1.

FIG. 5 is a perspective bottom view of the frame of FIG. 1.

FIG. 6 is a side view of two stacked frames.

FIG. 7 is a section view of the stacked frames of FIG. 6.

FIG. 8 is a perspective top view of the stacked frames of FIG. 6.

FIG. 9 is a perspective top view of another example of a water meter pit frame.

FIG. 10 is a section view of the water meter pit frame of FIG. 9.

FIG. 11 is a magnified view of a portion of FIG. 10.

FIG. 12 is a perspective top view of one example of a frost plate.

FIG. 13 is a perspective top view of two stacked frost plates.

FIG. 14 is a section view showing the frost plate of FIG. 12 in the water meter pit frame of FIG. 9.

### DETAILED DESCRIPTION OF THE PREFERRED EMBODIMENT

As shown in FIG. 14, a water meter cover 100 encloses a water meter pit 102, which is typically located within the ground 104. The water meter pit 102 houses equipment (not shown) for monitoring an amount of water that is being supplied to a commercial property or private residence, for example. The cover 100 typically includes a latch assembly 106 such that the cover 100 can be securely latched in place. The water meter pit cover 100 sits within a frame 110.

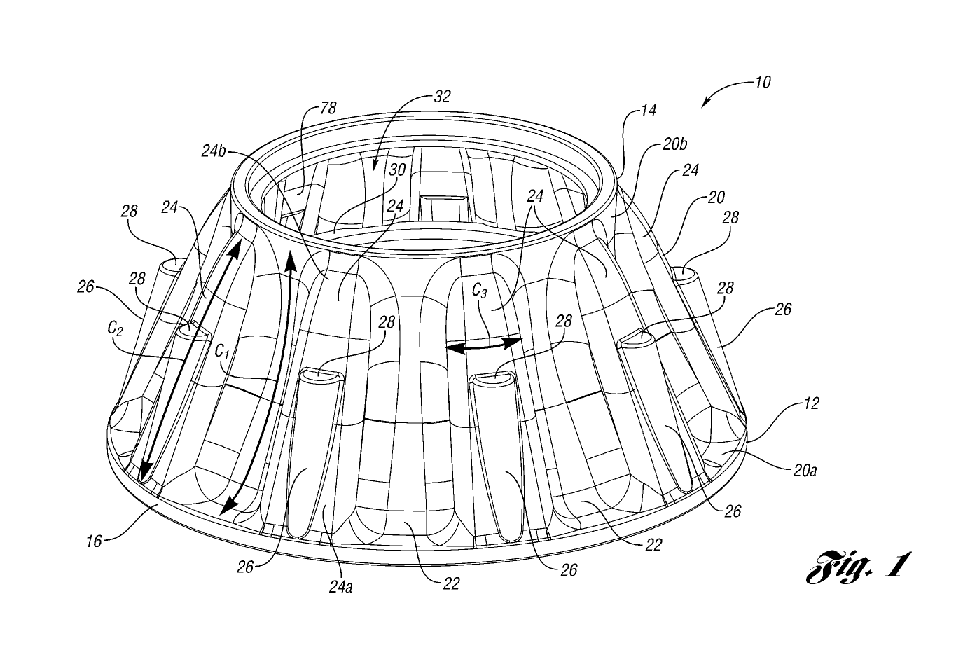

FIG. 1 shows another example of a frame 10 for a water meter pit. The frames 10, 110 each comprise a frame such as that disclosed in co-pending application Ser. No. 12/830,593, entitled One-Piece Water Meter Pit Frame, which is incorporated herein by reference. In one example, the frames 10, 110 are formed as a single-piece component using a roto-mold process. The specifics of each of these frames 10, 110 will be discussed in greater detail below.

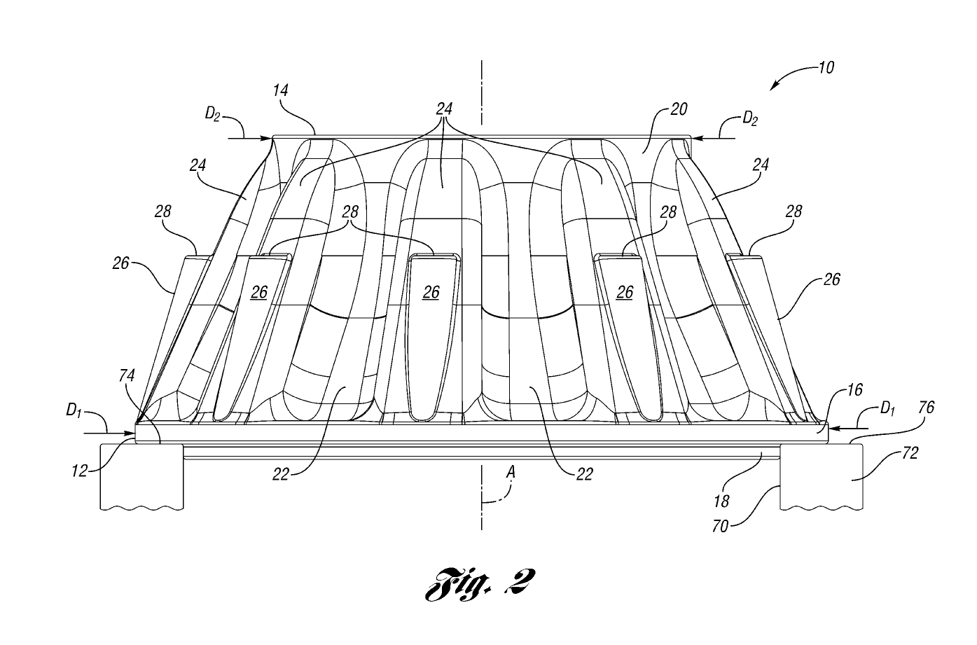

As shown in FIG. 1, the frame 10 extends from a base end 12 up to a top end 14 that receives the cover. The base end 12 includes an outer flange 16 that is formed about an outer periphery of the base end 12. A downwardly extending lip portion 18 (FIG. 2) is formed at the base end 12 and is received within a central opening 70 of an associated water pit column 72 that supports the frame 10 as known. The lip portion 18 is located radially inwardly of the outer flange 16. A bottom surface 74 of the outer flange 16 is configured to rest on an upper edge 76 of the water pit column 72 when the lip portion 18 is inserted into the opening 70 in the column 72.

As shown in FIG. 2, the frame 10 includes an outer surface 20 that decreases in diameter, i.e. tapers inwardly, from the outer flange 16 at the base end 12 to the top end 14. The outer flange 16 defines the largest outer diameter D1 of the plastic frame 10 and the top end 14 defines the smallest outer diameter D2.

In addition to tapering from a large diameter end to a smaller diameter end, the outer surface 20 is comprised as an inwardly extending arcuate surface 22 that is curved as indicated at C1 in FIG. 1. Due to the taper, a bottom portion 20a of the outer surface 20 is located radially outwardly relative to a top portion 20b of the outer surface 20. Thus, the frame 10 is configured to provide an inward arched frame shape.

The frame 10 is also provided with an exterior arcuate rib configuration that extends outwardly from the outer surface 20 to increase frame strength. A series of exterior ribs 24 are formed within the outer surface 20 and extend along the outer surface 20 from a location near the base end 12 in a direction toward the top end 14. The ribs 24 are circumferentially spaced apart from each about a center axis A (FIG. 2) defined by a center of the frame 10. Each rib 24 comprises a projecting or protruding portion that extends outwardly from the outer surface 20, with each rib 24 having an outwardly curved or arcuate surface being formed along a length of the rib 24 as indicated at C2 in FIG. 1. Further, this curved surface extends across a width of the rib 24 as indicated at C3.

Each rib 24 has base rib end 24a and a top rib end 24b. The ribs 24 are wider at the base rib ends 24a than at the top rib ends 24b. Thus, the ribs 24 form a series of finger-like protrusions that extend circumferentially about the frame 10. The outwardly curved ribs 24 are formed to complement the inward arched frame structure provided by the inwardly curved outer surface 20. The combination of these opposing shapes increases frame strength and decreases overall frame deflection.

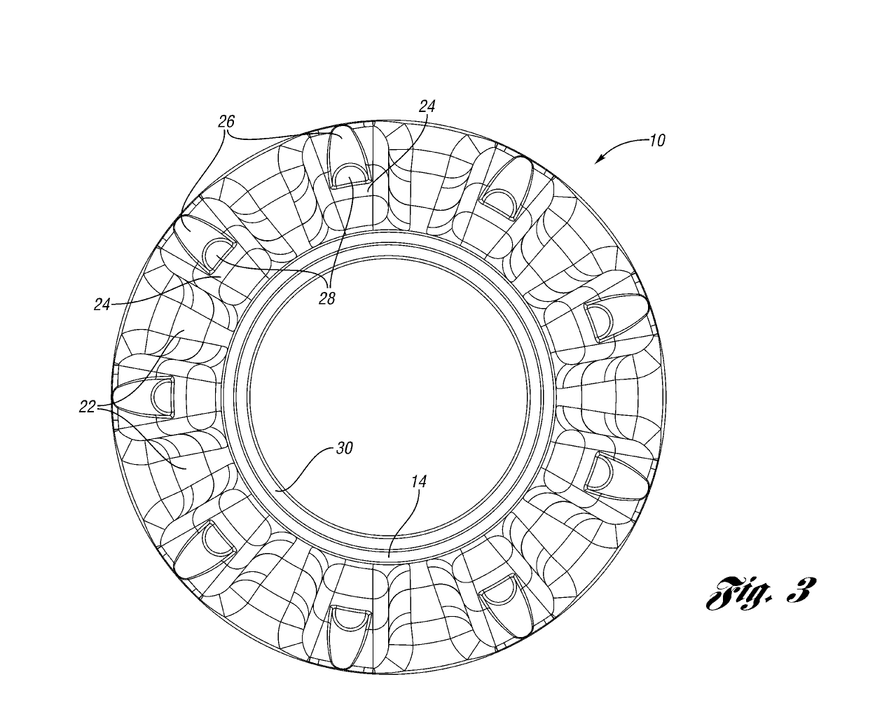

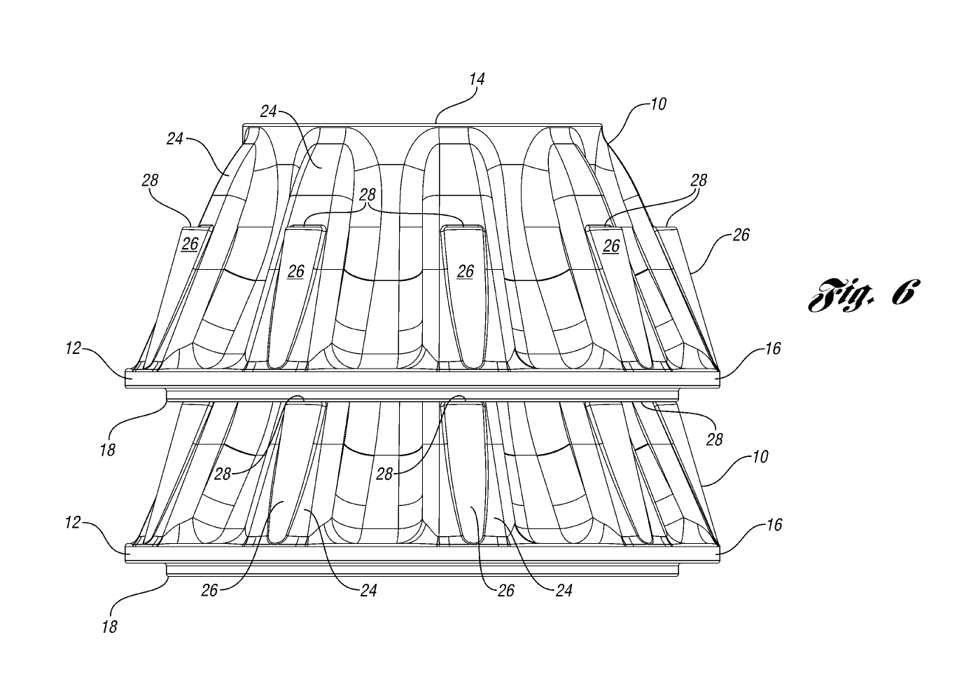

In one example, each rib 24 includes a secondary raised projection portion 26 that extends from the base rib ends 24a toward the top rib ends 24b. The secondary raised projection 26 terminates generally mid-way up the rib at a step-like ledge 28 (FIGS. 1 and 3). When a second frame 10 is nested on top of another frame as shown in FIG. 6, the step-like ledges 28 stabilize the frames so that they do not wobble when stacked. Thus, the ledges 28 comprise a stacking feature that allows a plurality of frames to be stacked together in a nested relationship.

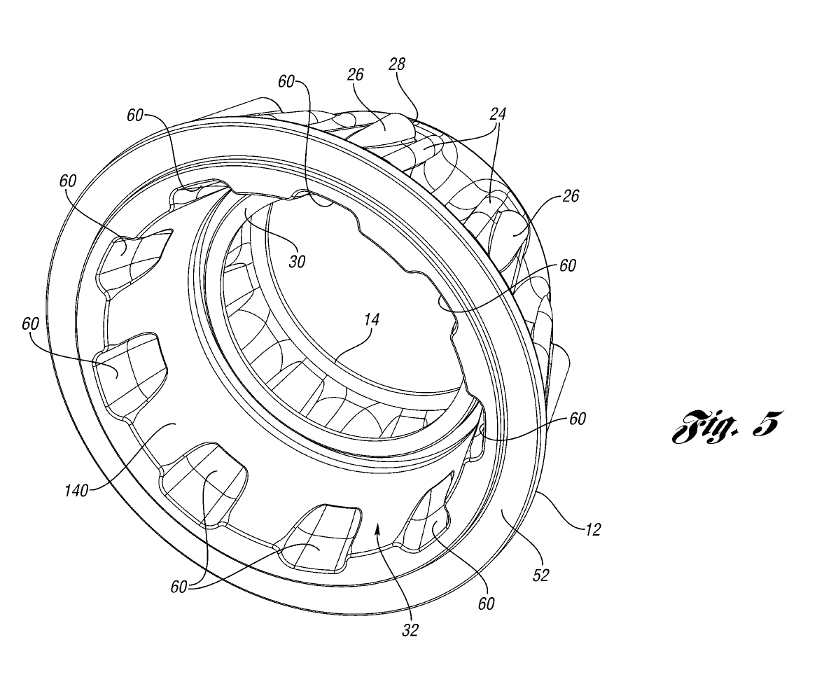

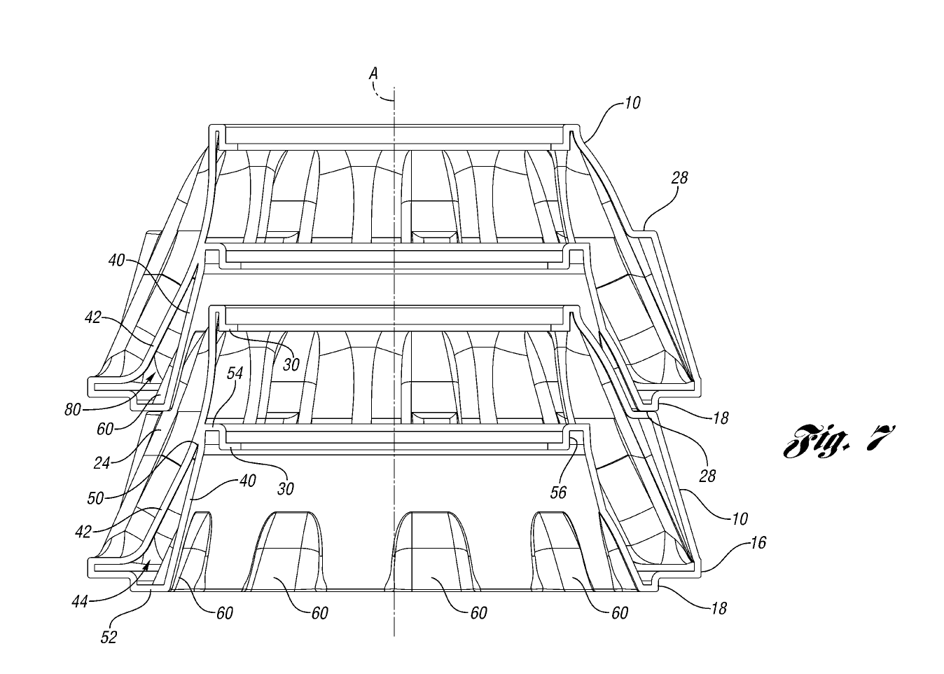

The frame 10 comprises a hollow structure with an internal cavity 32 defined by an inner peripheral surface 78 of the frame 10. The frame 10 includes an inwardly extending lip or flange portion 30 (FIGS. 5 and 7) that is integrally molded as part of the frame 10. The flange portion 30 extends in a direction radially inwardly from the inner peripheral surface 78. In the example shown, the flange portion 30 extends completely about the inner peripheral surface 78 of the hollow frame 10; however, the flange portion 30 could be formed to extend partially about the inner periphery or to extend inwardly at discrete locations about the inner periphery

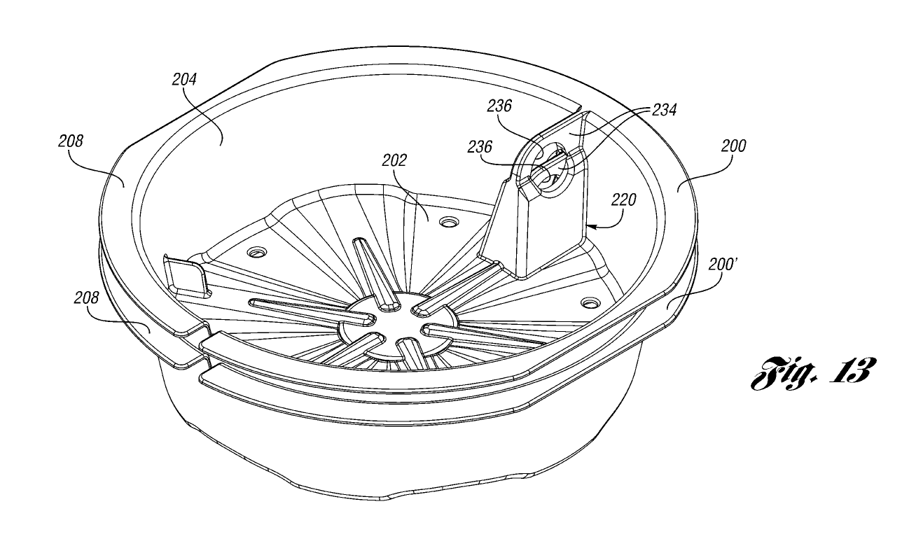

As shown, flange portion 30 extends radially inwardly toward the axis A, and is configured to support a frost plate 200 (see FIG. 12) that is received within the internal cavity 32 defined by the frame 10. The frost plate 200 comprises an optional structure that is not required for all meter pit frames. For example, water meter pit frames located in warmer climates would not need to utilize a frost plate.

Also as shown in FIG. 7, the frame 10 includes an inner wall structure 40 that is positioned radially inward of an outer wall structure 42 that defines the outer surface 20 of the frame 10. This forms a pocket portion 44 between the outer wall structure 42 and the inner wall structure 40. This double wall structure portion of the frame 10, i.e. the frame portion that forms the pocket portion 44, is formed generally in the lower half of the frame 10, i.e. is formed within the larger diameter portion of the frame 10. Areas where the inner wall structure 40 and the outer wall structure 42 contact each other are indicated at 50. These contact areas 50 are located where the outer wall structure 42 curves inwardly as indicated by C1 and adds strength to the frame 10.

An inwardly extending flange portion 52 extends radially inwardly to partially form the lip portion 18. The inner wall structure 40 tapers upwardly and inwardly from the flange portion 52 to a generally flat surface 54 that is positioned vertically above the flange portion 30 and below the top end 14 of the frame 10. A transition wall portion 56 extends downwardly from surface 54 to the flange portion 30, which supports the frost plate. This configuration increases the overall structural strength of the frame 10 as well as providing easy access to remove the frost plate if needed.

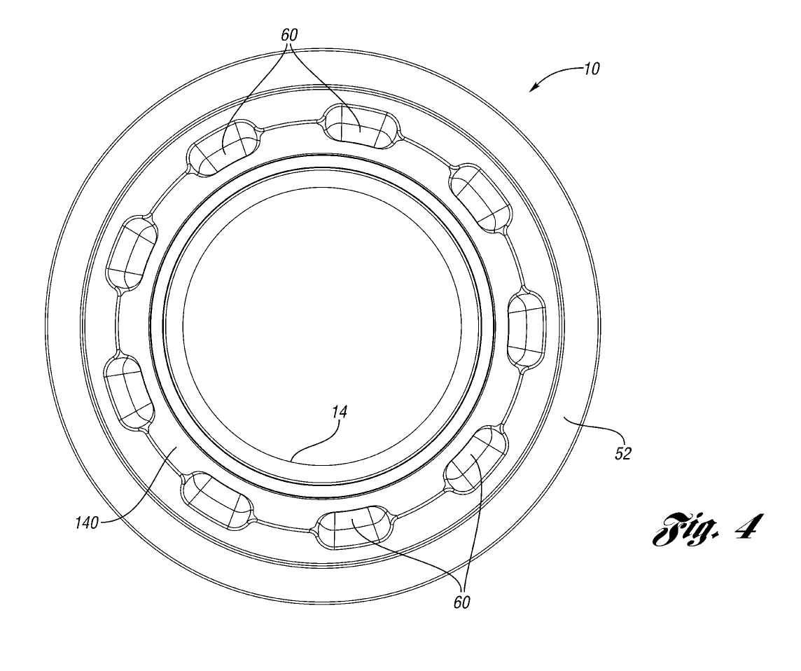

The inner wall structure 40 includes a plurality of recessed areas 60 (FIGS. 4, 5, and 7) that are circumferentially spaced about the axis A. The recessed areas 60 are open into the internal cavity 32 and protrude outwardly into the pocket portion 44 formed between the inner 40 and outer 42 wall structures as shown in FIG. 7.

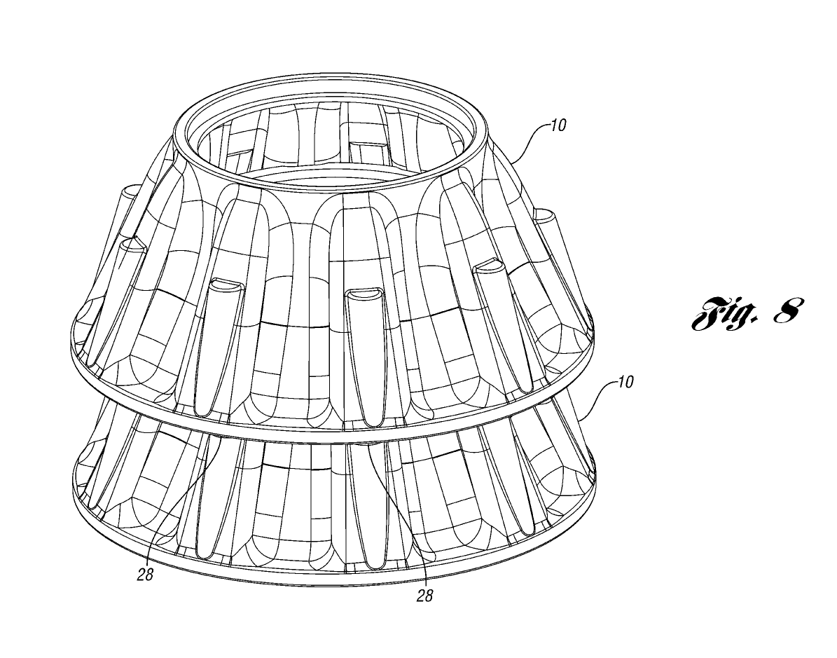

The recessed areas 60 allow a lower, second water meter pit frame 10 to fit up inside the upper, water meter pit frame 10 to provide a nested stacked configuration. The recessed areas 60 receive an upper portion of the protruding ribs 24, as shown at 80 in FIG. 7, and allow for a greater nesting increment, i.e. greater nesting depth, as well as providing a stabilizing function for stacked frames 10. The recessed areas 60 also serve to stop rotational movement of the stacked frames with respect to one another. The protruding lip portion 18 sits on the step-like ledge 28 to seat the upper frame on the lower frame in a stabilized stacked condition (FIGS. 6-8).

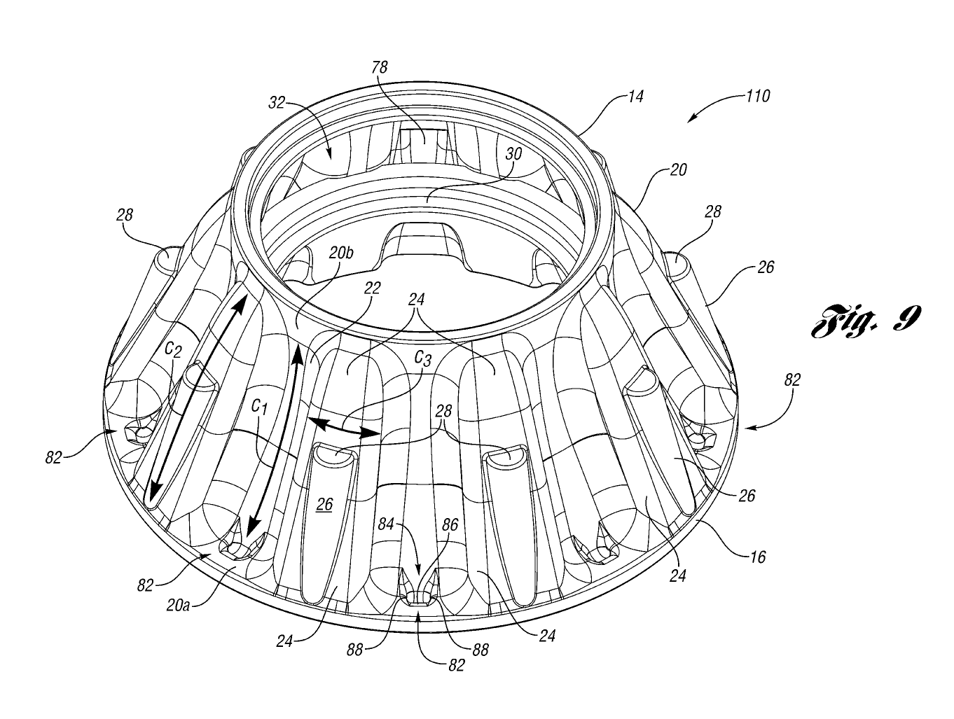

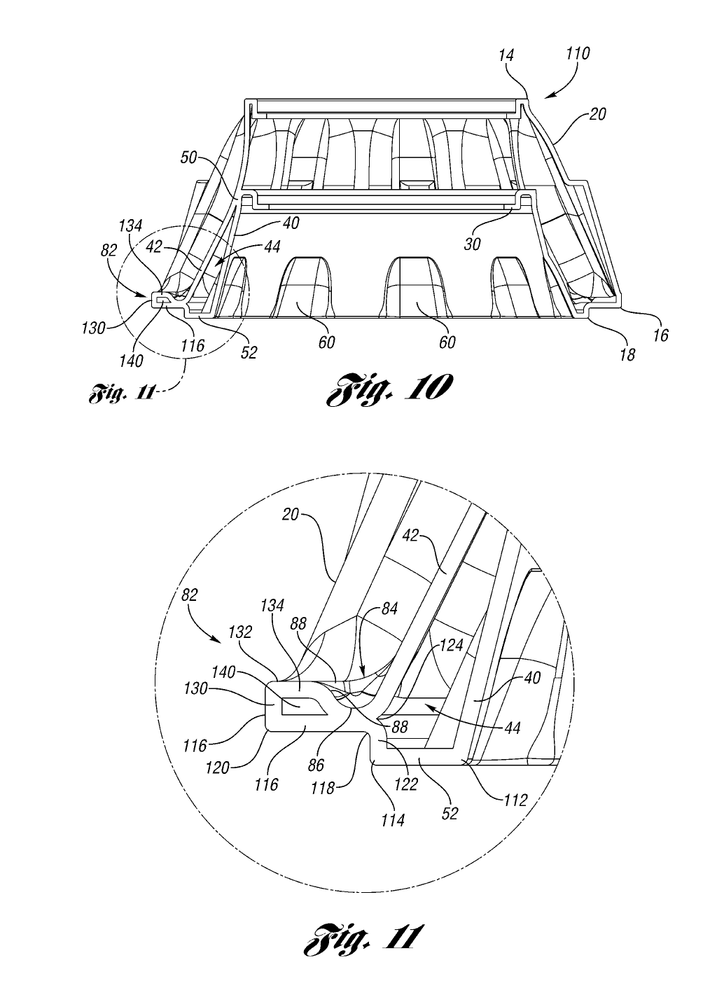

The frame 110 shown in FIG. 9 is similar to that shown in FIGS. 1-8, but includes an additional strengthening feature as indicated at 82. The outer surface 20 is comprised as an inwardly extending arcuate surface 22 that is curved as indicated at C1 in FIG. 9. Due to the taper, the bottom portion 20a of the outer surface 20 is located radially outwardly relative to the top portion 20b of the outer surface 20 to provide the inward arched frame shape. The additional strengthening feature 82 is formed near the bottom portion 20a of the frame 10 at the inwardly extending arcuate surface 22.

The strengthening feature 82 comprises a downwardly extending recess or dimple 84 that is formed as part of the bottom flange 16 and which is located radially outwardly relative to the pocket area 44. As viewed from the outer surface 20 of the frame 110, the dimple 84 comprises a bottom surface 86 with curved side walls 88 extending from locations adjacent to the ribs 24 downwardly to the bottom surface 86.

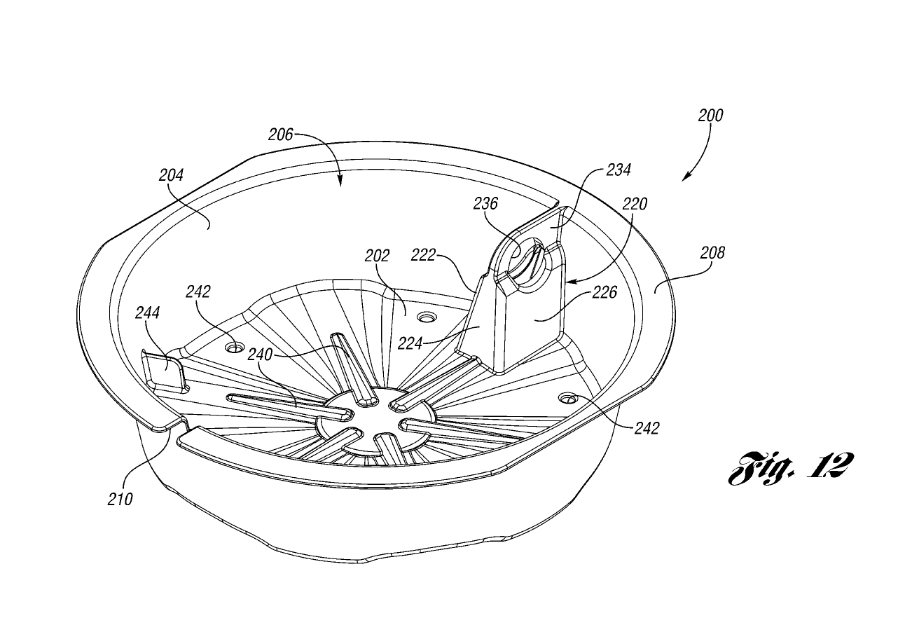

As shown in FIG. 11, the axially extending flange portion 52 extends from a radially inward end 112 to a radially outward end 114 as part of the lip portion 18. An axially extending flange portion 116 extends from a radially inward end 118 to a radially outward end 120 to form the flange 16. A transition wall 122 connects the radially outward end 114 of flange portion 52 to the radially inward end 118 of flange portion 116. The transition wall 122 extends vertically upwardly to connect to the outer wall structure 42 as indicated at 124. Thus, in this example configuration, the pocket portions 44 are bounded by the inner wall structure 40, outer wall structure 42, flange portion 52, and transition wall 122.

A vertical wall portion 130 extends upwardly from the radially outer end 120 of the flange 116 to an upper surface 132 of the flange 116. An upper wall portion 134 then extends radially inwardly from an upper end of the vertical wall portion 130 to an edge of the dimple 84. One of the curved side walls 88 then extends downwardly from a radially inner end of the upper wall portion 134 to the bottom surface 86 of the dimple 84. The upper wall portion 134 and flange portion 116 are vertically spaced apart from each other to form a secondary pocket 140. The secondary pocket 140 is bounded by the upper wall portion 134, flange portion 116, vertical wall portion 130 and curved side wall 88 as the wall extends to contact flange portion 116. The secondary pocket 140 is thus located radially outwardly relative to the primary pocket portion 44, which is larger in cross-sectional area than the secondary portion portions 140. The contact areas 50, 124 between the specified flanges and wall portions increases the overall strength of the frame 110.

FIG. 12 shows one example of a frost plate 200. The frost plate 200 includes a base wall 202 with a circumferential wall portion 204 extend upwardly about an outer periphery of the base wall 202 to form a cup-shaped structure having an open top 206. A cup flange 208 extends radially outwardly from an upper edge of the circumferential wall portion 204. The cup flange 208 sits on the inner flange 30 of the frame 110 when the frost plate 200 is installed within the frame 110 (see FIG. 14). The cup flange 208 can include one or more openings or slots 210 to allow wiring to pass through or around the frost plate 200.

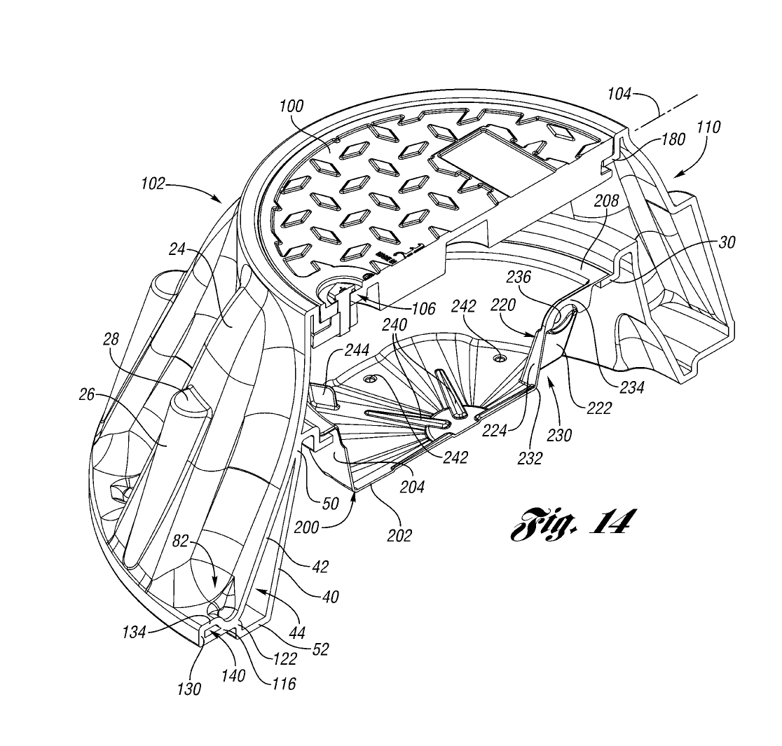

The frost plate 200 includes a finger grip 220 that extends radially inwardly from the circumferential wall portion 204. The finger grip 220 is comprised of upwardly extending wall portions 222, 224, 226, which are spaced apart from each other to form a hollow inner cavity 230 that has an open bottom end 232 (see FIG. 14). This allows one frost plate 200 to be easily stacked upon another frost plate 200′ in a nested relationship as shown in FIG. 13.

The upper edges of the wall portions 222, 224, 226 transition into a gripping flange portion 234. The gripping flange portion 234 includes an opening 236 such that a finger or tool can be inserted to easily pull the frost plate 200 out of the frame 110.

In one example, the frost plate 200 includes strengthening ribs 240 formed within the base wall 202. The base wall 202 may also include one or more drain holes 242. Additionally, strengthening flanges 244 may extend radially inwardly from the circumferential wall portion 204 to further increase strength of the frost plate.

In the example shown in FIG. 14, the cover 100 is installed into the frame 110 to sit on a lip 180 to enclose the frost plate 200 within the frame 110.

It should be understood that while the frost plate 200 is shown as being used with the frame configuration shown in FIGS. 9 and 14, the frost plate 200 could also be used with the frame 10 shown in FIG. 1. Both configurations provide frames and/or frost plates that are easily stackable and which have increased robustness compared to prior designs.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A water meter pit frame comprising:
a body including a base portion to be supported by a water pit column and a top portion to be releasably securable to a cover, the body having an outer peripheral surface and an inner peripheral surface defining an internal cavity; and
at least one stacking feature formed on said outer peripheral surface to support a second water meter pit frame when the body is at least partially nested within the second water meter pit frame.

2. The water meter pit frame according to claim 1 wherein the body is defined by a first diameter at the base portion and a second diameter at the top portion that is less than the first diameter, and wherein the body tapers inwardly from the base portion toward the top portion.

3. The water meter pit frame according to claim 1 wherein the frame comprises a one-piece structure extending from the base portion to the top portion.

4. The water meter pit frame according to claim 1 wherein the at least one stacking feature comprises a ledge that seats the second water meter pit frame.

5. The water meter pit frame according to claim 1 wherein the at least one stacking feature comprises a plurality of stacking features spaced circumferentially about the outer peripheral surface.

6. The water meter pit frame according to claim 5 wherein the plurality of stacking features comprises a plurality of ledges having an upper surface that abuts against a bottom surface of the second water meter pit frame.

7. The water meter pit frame according to claim 6 wherein said body includes a flange formed to extend radially outwardly about the base portion, and including a lip extending vertically downwardly from a radially inward portion of the flange, and wherein the bottom surface of the second water meter pit comprises a bottom surface of the lip.

8. The water meter pit frame according to claim 6 including a plurality of ribs formed about the outer peripheral surface of the body and circumferentially spaced apart from each other, and wherein each rib comprise a curved outer surface.

9. The water meter pit frame according to claim 8 wherein each rib includes a secondary raised projection portion that extends from a base of the rib toward a top of the rib, and wherein the secondary raised projection terminates generally mid-way up the associated rib at the ledge.

10. The water meter pit frame according to claim 8 wherein the inner peripheral surface includes a plurality of recessed areas to receive a plurality of ribs formed on a third water meter pit frame when the third water meter pit frame is at least partially nested within the body.

11. The water meter pit frame according to claim 1 wherein the inner peripheral surface includes a plurality of recessed areas to receive a locating feature formed on a third water meter pit frame when the third water meter pit frame is at least partially nested within the body, and wherein the recessed areas and locating feature cooperate to prevent rotation between the body and the third water meter pit frame when stacked.

12. The water meter pit frame according to claim 1 wherein the body includes an inner wall structure that is positioned radially inward of an outer wall structure that defines the outer peripheral surface of the body to form a pocket portion between the outer wall structure and the inner wall structure.

13. The water meter pit frame according to claim 12 including a flange portion extending radially inwardly from the inner peripheral surface, wherein the flange portion comprises a frost plate seat.

14. The water meter pit frame according to claim 13 wherein an upper edge of the pocket portion terminates adjacent the flange portion.

15. The water meter pit frame according to claim 12 wherein the body includes a flange formed to extend radially outwardly about the base portion, and including a plurality of downwardly extending dimples that are formed as part of the flange and which are spaced circumferentially apart from each other and are located radially outwardly relative to the pocket portion.

16. The water meter pit frame according to claim 15 including a secondary pocket portion formed within the flange and located radially outwardly of each dimple.

17. The water meter pit frame according to claim 1 including a flange portion extending radially inwardly from the inner peripheral surface and a frost plate seated on the flange portion.

18. The water meter pit frame according to claim 17 wherein the frost plate includes at least one frost plate stacking feature to cooperate with a corresponding frost plate stacking feature on a second front plate.

19. The water meter pit frame according to claim 18 wherein the at least one frost plate stacking feature comprises a raised feature extending upwardly from the frost plate to define a hollow area underneath the frost plate, and where the hollow area receives a corresponding raised feature of the second frost plate when the second frost plate is stacked on the frost plate.

20. The water meter pit frame according to claim 19 wherein the raised feature includes a finger grip.

21. A water meter pit frame comprising:
a body including a base portion to be supported by a water pit column and a top portion to be releasably securable to a cover, the body having an outer peripheral surface and an inner peripheral surface defining an internal cavity, and the body tapering radially inwardly from the base portion toward the top portion;
a plurality of ribs formed about an the outer peripheral surface;
a plurality of secondary raised projections, with one secondary raised projection being associated with each rib; and
a ledge formed at an upper end of each secondary raised projection.

22. The water meter pit frame according to claim 21 wherein each ledge is located generally near a middle of each rib.

23. The water meter pit frame according to claim 21 wherein the inner peripheral surface includes a plurality of recessed areas formed within the base portion.

24. The water meter pit frame according to claim 21 including a flange formed to extend radially outwardly about the base portion, and including a plurality of downwardly extending dimples that are formed as part of the flange and which are spaced circumferentially apart from each other with one dimple being located between each pair of adjacent ribs.

25. The water meter pit frame according to claim 24 wherein the body includes an inner wall structure that is positioned radially inward of an outer wall structure that defines the outer peripheral surface of the body to form a pocket portion between the outer wall structure and the inner wall structure, and including a secondary pocket portion formed within the flange and located radially outwardly of each dimple.

26. A plurality of water meter pit frames comprising:
a first water meter pit frame having a first stacking feature;
a second water meter pit frame having a second stacking feature that cooperates with the first stacking feature to support the first and second water meter pit frames in a nested relationship.

27. The plurality of water meter pit frames according to claim 26 wherein the first stacking feature comprises a plurality of ledges formed about an outer peripheral surface of the first water meter pit frame and the second stacking feature comprises a seat formed on the second water meter pit frame that rests on the ledges.

28. The plurality of water meter pit frames according to claim 27 wherein the seat comprises a downwardly extending lip.

29. The plurality of water meter pit frames according to claim 27 wherein the first water meter pit includes a third stacking feature that cooperates with a fourth stacking feature on a third water meter pit frame when the third water meter pit frame is nested within the first water meter pit frame.

30. The plurality of water meter pit frames according to claim 29 wherein the third stacking feature comprises a plurality of recesses formed within an inner peripheral surface of the first water meter pit frame and the fourth stacking feature comprises a plurality of circumferentially spaced ribs formed within an outer peripheral surface of the third water meter pit frame.

31. A water meter pit frame comprising:
a body including a base portion to be supported by a water pit column and a top portion to be releasably securable to a cover, the body having an outer peripheral surface and an inner peripheral surface defining an internal cavity, and the body tapering radially inwardly from the base portion toward the top portion; and
wherein the body includes an inner wall structure that is positioned radially inward of an outer wall structure that defines the outer peripheral surface of the body to form a pocket portion between the outer wall structure and the inner wall structure.

32. The water meter pit frame according to claim 31 wherein the body comprises a single-piece structure.

33. The water meter pit frame according to claim 32 including a flange portion extending radially inwardly from the inner peripheral surface, wherein the flange portion comprises a frost plate seat, and wherein an upper edge of the pocket portion terminates adjacent the flange portion.

34. A frost plate for a water meter pit frame comprising:
a cup-shaped body having a bottom and an circumferential wall portion extending upwardly from the bottom; and
at least one stacking feature formed in the bottom to support a second frost plate in a stacked relationship.

35. The frost plate according to claim 34 wherein the stacking feature comprises a raised portion extending upwardly from the bottom to define a hollow area underneath the bottom, and where the hollow area receives a corresponding raised feature of the second frost plate when stacked.
